(19) United States
(12) Patent Application Publication
(10) Pub. No.: US 2006/0259475 A1
(43) Pub. Date: Nov. 16, 2006

(54) Database system and method for retrieving records from a record library

(76) Inventor: Peter J. Dehlinger, Palo Alto, CA (US)

Correspondence Address: PERKINS COIE LLP, P.O. BOX 2168, MENLO PARK, CA, 94026, US

(21) Appl. No.: 11/403,280

(22) Filed: Apr. 12, 2006

Related U.S. Application Data
(60) Provisional application No. 60/679,851, filed on May 10, 2005.

(51) Int. Cl. G06F 17/30

(52) U.S. Cl. 707/3

(57) ABSTRACT

Disclosed are a computer-readable code, system and method for retrieving one or more records stored in electronic form in a library of records. The program that executes the method accesses a database table to identify, from user-generated information, one or more phrases likely to be contained in or associated with a record of interest, and from these phrase(s), identifies one or more phrase-related tags. The program uses the one or more tags so identified to find, independent of user input, test tags associated with those already identified, and to present to the user the number of records associated with the test tags, allowing the user to find records based on the inclusion of known tags and associated phrases.

This application claims priority to U.S. provisional patent application Ser. No. 60/679,851 filed on May 10, 2005, which is incorporated herein in its entirety by reference.

### FIELD OF THE INVENTION

The present invention relates to a database system and method for retrieving a record of interest from a library of records, based on record-descriptive phrases contained in the records.

### BACKGROUND OF THE INVENTION

One of the major challenges in managing information is in accurately and efficiently locating text-based records of interest among large libraries of records. The records may be legal documents or reported case-law decisions in a law-firm or legal-search database, or scientific or technical or other scholarly publications in a research or academic or database library, or patents or published patent applications stored in a patent repository. In an institutional or website setting, the records could be related to such diverse kinds of records as individuals or disease conditions that one is trying to identify out of a large number of records.

A variety of tools for managing and retrieving text-based records are available commercially. These systems store document information in database form, allowing user retrieval of the documents by key-word searching of the overall document text. Because of the number of documents that may be stored in the records library, e.g., tens of thousands to millions of records, a key-word search of the document text may lack sufficient precision to provide a useful discriminator among a large number of similar records, even if the records have been pre-classified into smaller, individually searchable record subsets.

It would therefore be desirable to provide an improved system for managing and retrieving records from a large record library. In particular, the system should be able to efficiently discriminate records on the basis of a relatively small number of content-rich phrases which are contained in or otherwise characterize each record.

### SUMMARY OF THE INVENTION

The invention includes, in one aspect, a computer database method for finding a record of interest in a library of records characterized by distinctive subsets of tag descriptors. The steps in the method include:

(a) accessing a database table to identify, from user-generated information, one or more tag-descriptive phrases likely to be contained in or associated with a record of interest,

(b) from the phrase(s) identified in step (a), identifying one or more tags associated with the identified phrase(s),

(c) accessing a tag-affinity database table to identify test tags associated in the library records with those identified in step (b),

(d) accessing a database table of searchable tags, to generate for each of the test tags identified in step (c), data related to the number of library records containing in or associated with that test tag and the tags identified in step (b), and

(e) presenting the number-of-records data generated in (d) to a user.

Step (a) in the method may include the steps of (ai) accessing a word-records database table composed of searchable words, and for each word in the table, a list of identifiers of phrases containing that word, to identify from a user-generated, word-based query, those phrases having the highest element overlap with the query words, and (aii) presenting those highest-overlap phrases to the user, for user selection of one or more phrases.

Step (b) may include accessing a phrase database table composed of phrase identifiers, and for each phrase identifier, a list of one or more tags associated with that phrase, to identify one or more tags associated with the phrase(s) identified in step (a). The phrase database table may further include, for each phrase identifier, the actual phrase associated with each phrase identifier, and step (a) may include accessing the searchable-phrase table to retrieve and present to the user, the actual phrase(s) associated with the identified phrase identifier(s).

Steps (a) and (b) may be carried out iteratively, prior to step (c), where each successive iteration yields one or more newly identified phrases and associated tags to add to the previously identified phrases and associated tags from all previous iterations. At each iteration, there may be displayed along with those phrases identified in step (a), the number of library records containing both previously identified and newly identified tags, where the iterations of steps (a) and (b) are continued until the number of records containing the selected and identified tags is desirably small.

The affinity database table accessed in step (c) may be a t×t matrix of all tags t associated with the records, and the matrix values for each word pair in the matrix is related to the number occurrence of both tags in the pair in the records.

Step (d) in the method may include (d1) determining for each of the tags identified in (c), the total number of library records containing that test tag and one or more of the previously identified tags previously identified by steps (a) and (b), (d2) displaying those test tags identified from step (c) having the highest total number of library records determined from (d1), along with the number of records so determined, and (d3) allowing the user to select one or more tags displayed in (d2).

Each tag in the database table of searchable tags accessed in step (d) may be represented as an N-dimensional vector, where N is the total number of library records in the system, and the coefficient of each vector term is a binary coefficient that indicates whether that tag is in the associated library record represented by that term, and step (d1) may include adding the vectors corresponding to one or more previously identified tags with that of a test tag by AND addition of the vector coefficients, and counting the coefficients from the added vectors. Where the one or more tags identified in step (b) includes two or more groups of tags identified from two or more iterations of steps (a) and (b), respectively, where each group includes one or more tags, step (d1) may include adding the coefficients of vectors in each group by OR addition, to generate a group vector, then adding the group vector(s) with that of a test tag by AND addition, and counting the coefficients in the summed vector.

Step (e) may further include selecting one or more tags presented in step (e), adding the selected tags to those identified in step (b), and repeating steps (c)-(e), until a desirably small number of records are presented in step (e).

For finding a record document of interest in a library of citation-rich documents, the tags may be citations appearing in the documents and the phrases, statements or propositions in the documents in close proximity to the citations.

For finding a record patent of interest in a library of patents, the tags may be class and subclass numbers assigned to the patents and the phrases, definitions of the classes and subclasses associated with the classification numbers.

For finding a disease record in a library of disease records, the tags may be symptom identifiers, and the phrases, descriptions of symptoms associated with the tags.

For finding a subject record in a library of subject records, the tags may be personality or preference identifiers, and the phrases, descriptions of personality or preference traits associated with said tags.

In another aspect, the invention includes a database system for finding a record of interest in a library of records characterized by distinctive subsets of tag descriptors. The system includes a computer, database tables accessible by the computer, and computer-readable code executable by the computer.

The database tables include (i) a word-records table composed of searchable words, and for each word in the table, a list of identifiers of phrases containing that word, (ii) a phrase table composed of phrase identifiers, and for each phrase identifier, a list of one or more tags associated with that phrase, (iii) an affinity matrix whose matrix values represent, for each pair of tags in the system, a number related to the affinity of the two tags of the pair in the records, and (iv) a tag table in which each tag is represented as an N-dimensional vector, where N is the total number of library records in the system, and the coefficient of each vector term is a binary coefficient that indicates whether that tag is in the associated library record represented by that term.

The computer-readable code operates to (i) access the word-records table to identify, from user-generated information, one or more phrases likely to be contained in or associated with a record of interest, (ii) access the phrase table to identify one or more tags associated with the phrase(s) identified in (i), (iii) access the affinity matrix to identify additional test tags associated in the library records with those identified in step (ii), and (iv) access the tag table to generate for each of the test tags identified in step (iii), data related to the number of library records containing in or associated with that test tag and the tags identified in step (ii), and (v) present the number-of-records data generated in (iv) to a user.

The affinity matrix may be a t×t matrix of all tags t associated with the records, and the matrix values for each word pair in the matrix is related to the number occurrence of both tags in the pair in the records. The sum of the matrix values of each row of the matrix may be normalized to a common value, e.g., 1.

Also disclosed is a database for use by an electronic computer for finding a record of interest in a library of records characterized by distinctive subsets of tag descriptors. The database includes (i) a word-records table composed of searchable words, and for each word in the table, a list of identifiers of phrases containing that word, (ii) a phrase table composed of phrase identifiers, and for each phrase identifier, a list of one or more tags associated with that phrase, (iii) an affinity matrix whose matrix values represent, for each pair of tags in the system, a number related to the affinity of the two tags of the pair in the records, and (iv) a tag table in which each tag is represented as an N-dimensional vector, where N is the total number of library records in the system, and the coefficient of each vector term is a binary coefficient that indicates whether that tag is in the associated library record represented by that term.

These and other objects and features of the invention will become more fully apparent when the following detailed description of the invention is read in conjunction with the accompanying drawings.

### BRIEF DESCRIPTION OF THE DRAWINGS

FIG. 1 shows hardware and database components of the system of the invention;

FIG. 2 shows, in summary diagram form, the processing of citation-rich documents to form several of the database tables in the database of the invention;

FIGS. 3A-3D show representative table entries in a phrase-ID table (3A), a word-records table (3B), a tag-ID table (3C), and a record-ID table (3D);

FIGS. 4A and 4B show in flow diagram form, operations in processing citation-rich documents, such as a legal document, to form the phrase-ID table, record-ID table, and tag-ID table in the database in one embodiment of the invention (4A), and in assigning tag IDs (4B);

FIG. 5 is a flow diagram of steps used in generating a word-records table in the database of the invention;

FIGS. 6A and 6B are flow diagrams of steps used in generating a co-occurrence matrix (6A) and a co-cluster matrix (6B) in the database of the invention;

FIG. 7 is a summary flow diagram of steps for retrieving a record of interest in a library of citation-rich documents, in accordance with the method of the invention;

FIG. 8 is a flow diagram of steps employed in matching a word query with a phrase in the method of the invention;

FIG. 9 is a flow diagram of steps used in ranking top-ranked citations (tags) according to citation date and number of citation-containing documents;

FIG. 10 shows two groups of rows from a co-occurrence matrix, for identifying tag that are related to the selected tag represented by the rows;

FIG. 11 shows steps employed in the system for identifying tags related to two groups of tags;

FIG. 12 shows record vectors for two groups of selected tags, and the record vector for a test tag, for calculating the record occurrence of test tags, when combined with the selected tags;

FIG. 13 shows steps employed in calculating test-tag record scores, according to one embodiment of the invention;

FIGS. 14A-14E are Venn diagram showing record subsets in a typical record search involving two user-directed search steps (FIGS. 14A and 14B) and three system-directed steps (FIGS. 14C-14E); and

FIG. 15 shows a user interface for the system of the invention.

### DETAILED DESCRIPTION OF THE INVENTION

A. Definitions

A “phrase” is a statement, definition or description of an idea, condition, person, or object, typically expressed as a single sentence or a phrase in a natural language, e.g., English. A phrase may typically be expressed by any of a number of words and syntactical constructions used in describing or defining a given concept, idea, trait, or physical object:

Examples of phrases include:

(i) statements representing a pithy summary of a holding or conclusion associated with a cited reference, such as a legal case-law or scientific or other scholarly reference,

(ii) definitions in a classification system, such as definitions of classes and subclasses in a patent classification system,

(iii) descriptions of symptoms, e.g., a physical symptoms related to health, and

(iv) descriptions of a personality or behavioral trait.

A “tag” is an identifier associated with a phrase. Examples of tags include reference or bibliographic citations, classification numbers or other identifiers or simply alphanumeric symbols assigned to a given phrase. Every phrase is associated with one or more tags, and every tag is associated with one or more phrases.

A “record” is a document or file containing or characterized by a group of phrases and/or a group of tags. Ideally, each record (or small subset of records) can be uniquely identified by some distinctive combination or tags associated with that record, and therefore, can also be identified by some unique combination of corresponding phrases. A record may contain both phrase and associated tags, or the tags may be assigned to phrases contained in a record, or phases may be assigned to tags in the record. Examples of records include:

(i) legal documents, such as legal opinions, briefs, and case-law decisions containing a number of legal citations (tags) and for each citation, a statement or proposition of the law associated with that citation.

(ii) scientific articles or other scholarly publications containing a number of bibliographic citations (tags) and for each citation, a statement or proposition or summary associated with that citation;

(iii) patents and patent applications having assigned to them, a plurality of class and subclass numbers (tags), where each class/subclass number has associated with it, a class/subclass definition (phrase);

(iv) record representing conditions or states, such as records of all human or animal diseases or disease states, where each record is characterized by a unqiue or nearly unique set of symptoms (phrases) characteristic of a given condition, and each symptom (phrase) has an identifying tag assigned to it; and

(v) records representing each of a typically large number of objects, such as the individuals in a large group, where each record contains a set of characteristics or traits or preferences, such as personality traits (the phrases) of an individual, and each trait or characteristic (phrases) has an identifying tag assigned to it.

The latter two record types may consist of a list of phrases, a list of tags, or both. A record typically contains a plurality, e.g., at least three and typically 10-20 or more tags.

A “tag descriptor” refers to a tag, and simply implies that the tag is a descriptor of the record which contains it, meaning that the phrase associated with the tag is descriptive of the content of subject matter of that record.

A “search query” refers to a single sentence or a sentence fragment or fragments or list of words and/or word groups that are descriptive of the content of a phrase or text to be searched.

A “verb-root word” is a word or phrase that has a verb root. Thus, the word “light” or “lights” (the noun), “light” (the adjective), “lightly” (the adverb) and various forms of “light” (the verb), such as light, lighted, lighting, lit, lights, to light, has been lighted, etc., are all verb-root words with the same verb root form “light,” where the verb root form selected is typically the present-tense singular (infinitive) form of the verb.

“Generic words” refers to words in a natural-language passage that are not descriptive of, or only non-specifically descriptive of, the subject matter of the passage. Examples include prepositions, conjunctions, pronouns, as well as certain nouns, verbs, adverbs, and adjectives that occur frequently in passages from many different fields. “Non-generic words” are those words in a passage remaining after generic words are removed.

A “word group” is a group, typically a word pair, of non-generic words that are proximately arranged in a natural-language passage. Typically, words in a word group are non-generic words in the same sentence. More typically they are nearest or next-nearest non-generic word neighbor in a string of non-generic words, e.g., a word string. Words and optionally, words groups, usually encompassing non-generic words and wordpairs generated from proximately arranged non-generic words, are also referred to herein as “terms”.

A “record (or document) identifier” or “RID” identifies a particular digitally encoded or processed record, e.g., document in a database of records, e.g., by a record number, i.e., a computer-readable alphanumeric code.

A “phrase (or statement) identifier” or “PID” identifies a particular phrase, e.g., statement, by a phrase number.

A “tag (or citation) identifier” or “TID” identifies a particular tag, e.g., by a tag number.

A “database” refers to a database of tables containing information about records and/or other record-related information. A database typically includes two or more tables, each containing locators by which information in one table can be used to access information in another table or tables.

B. System Components

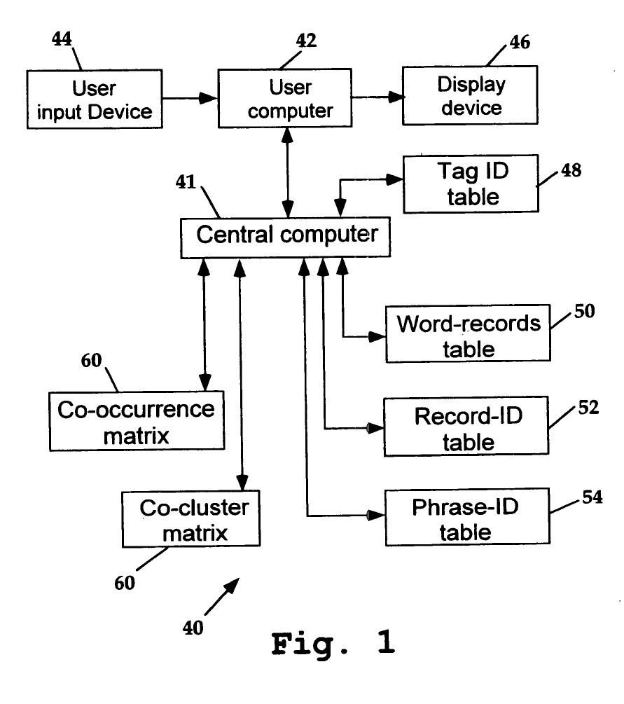

FIG. 1 shows the basic components of a system 40 for use in finding a record of interest in a database of stored records. A computer or processor 42 in the system may be a stand-alone computer or a central computer or server that communicates with a user's personal computer. The computer has an input device 44, such as a keyboard, modem, and/or disc reader, by which the user can enter queries and make phrase and tag selections, as will be seen below. A display or monitor 46 displays the interface described below with respect to FIG. 13. Computer 42 in the system is typically one of many user terminal computers, each of which communicates with a central server or processor 41 on which the main program activity in the system takes place.

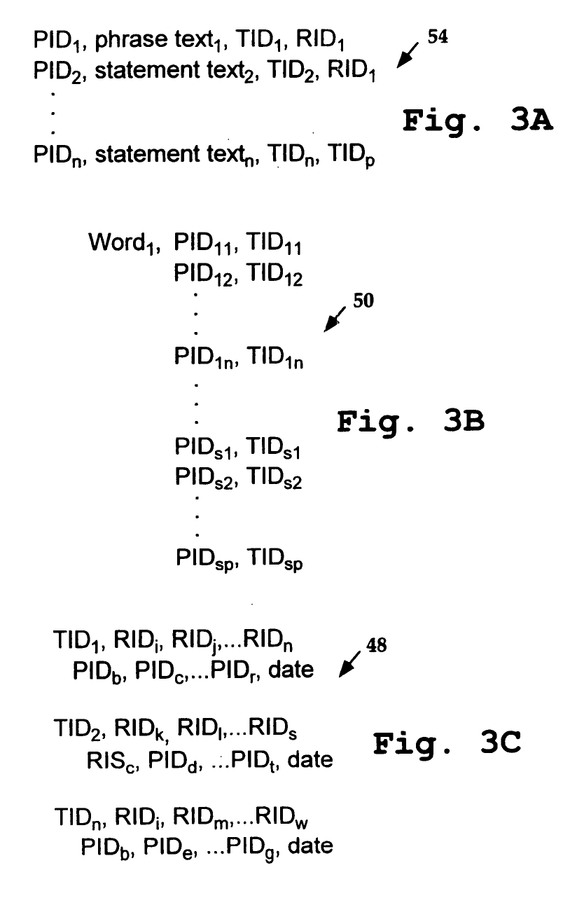

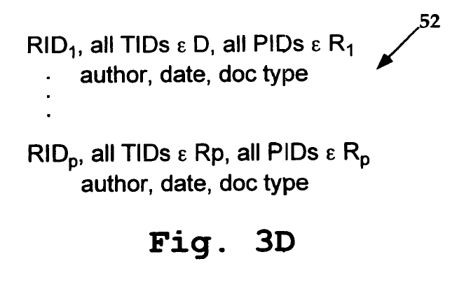

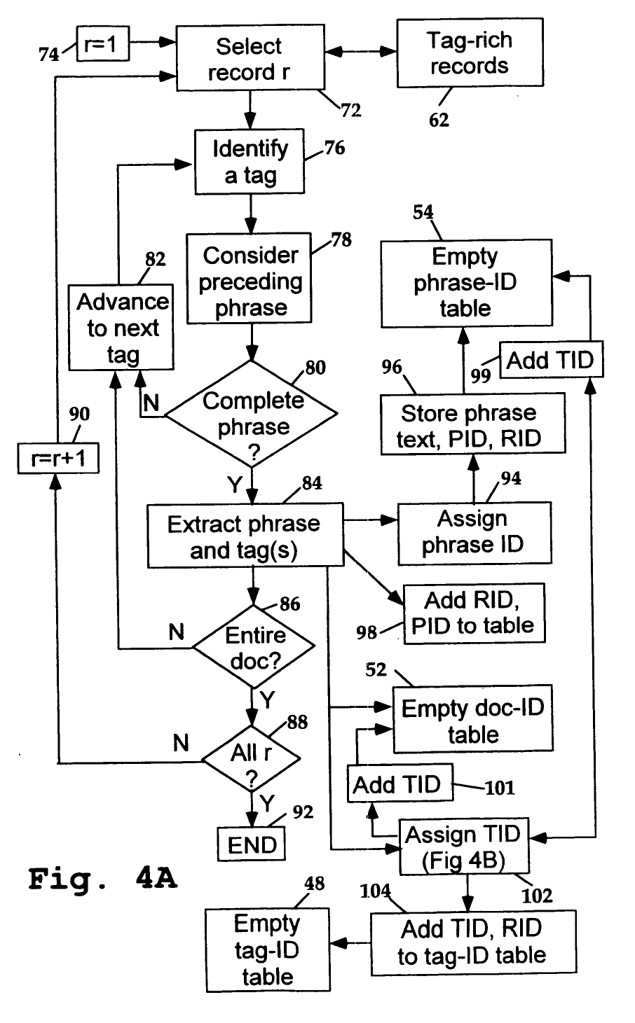

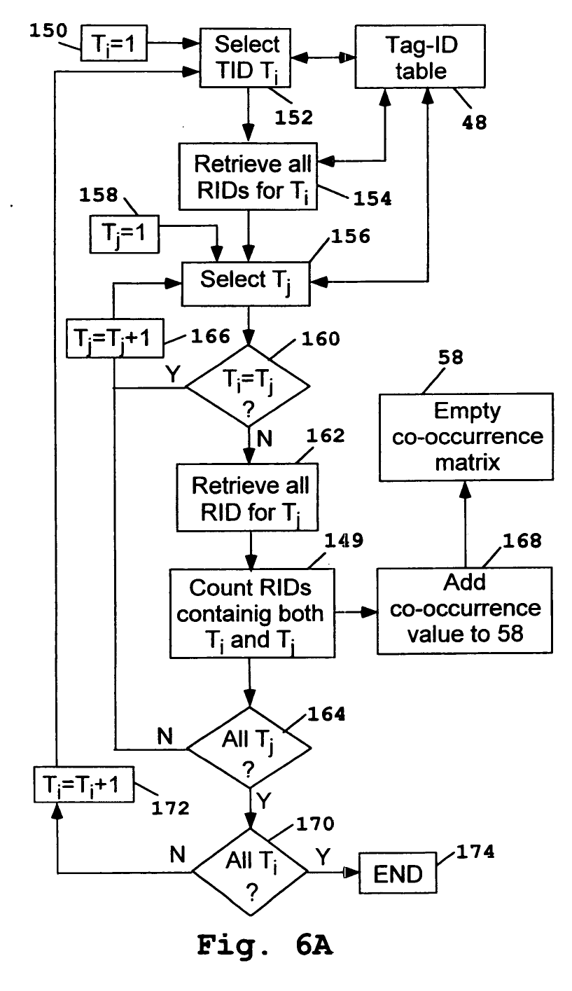

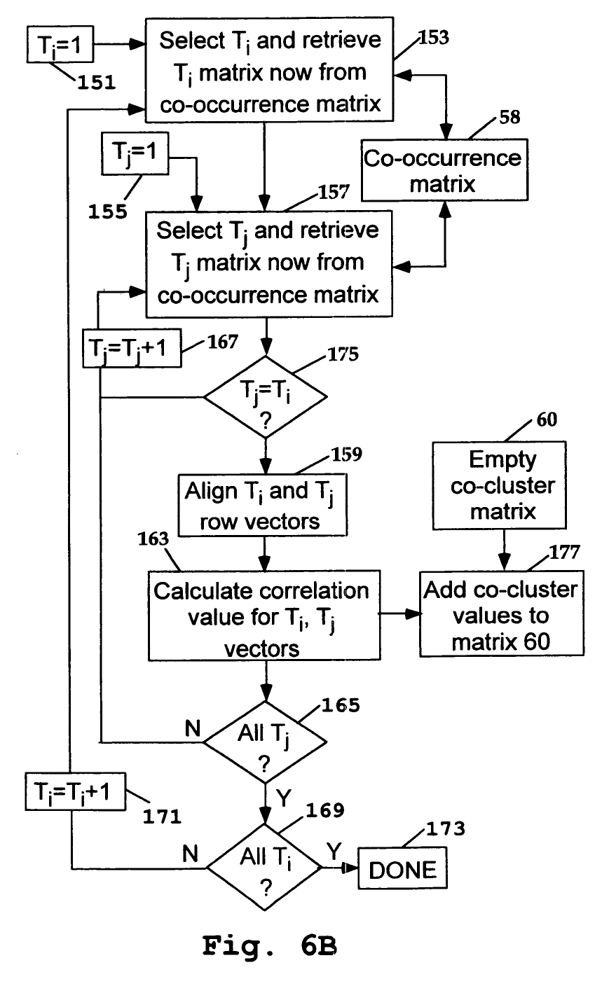

A database in the system, typically run on processor 41, includes a tag-ID table 48, a word-records table 50, a record-ID-table 52, and a phrase-ID table 54, all of which will be described below, e.g., with reference to FIGS. 3A-3D. Also included in the database is an affinity or co-occurrence matrix 60 and a co-cluster matrix 58 which are described below with reference to FIGS. 6A and 6B, respectively. The database also includes a database tool that operates on the server to access and act on information contained in the database tables, in accordance with the program steps described below. One exemplary database tool is MySQL database tool, which can be accessed at www.mysql.com.

It will be appreciated that the assignment of various stored records, databases, database tools and search modules, to be detailed below, to a user computer or a central server or central processing station is made on the basis of computer storage capacity and speed of operations, but may be modified without altering the basic functions and operations to be described.

C. Processing Records to Extract Phrases and/or Tags

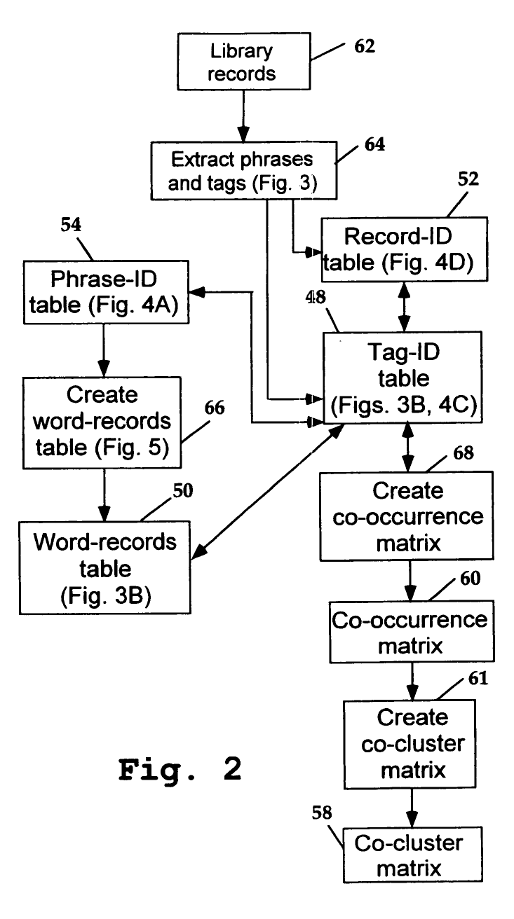

FIG. 2 is a flow diagram of the high-level steps used in processing records to extract phrases and/or tags to produce the various database tables and matrices employed in the system. For purposes of illustration, the records that will be described here and in the following sections are citation-rich documents, such as legal documents, where the actual citations in the documents represent the tags in the system, and statements associated with the citations represent the phrases. After describing the operation of the system for extracting statements and citations from the citation-rich document, the analogous operation of the system in extracting phrases and/or tags from a variety of other types of records will be considered.

The citation-rich documents (library records), indicated at 62 in FIG. 2, may be any collection, typically a large collection of up to several thousand to several million documents, such as a large collection of scientific or scholarly publications, reported legal cases, e.g., appellate cases, or legal documents such as opinions and briefs, all of which contain multiple citations or cites, e.g., references to other cases or other articles or scholarly works.

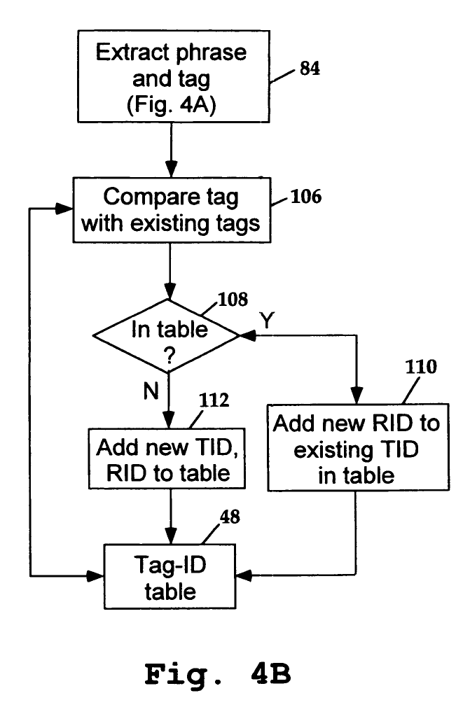

The program operates to extract the cites (tags) from the documents, and the typically the statement (phrase) that the cite “stands for” in that particular document. This step, which is indicated at 64 in FIG. 2, will be detailed below with reference to FIG. 4A. Each statement (phrase) extracted from a document (and identified with one or more cites) is placed in phrase-ID table 54, which has as its key locator, a phrase identifier (PID), where each phrase has a separate identifier. FIG. 3A shows typically table entries that include, for each PIDᵢ entry, the text of the extracted phrase, a tag identifier (TlDⱼ) that identifies the citation (tag) associated with that statement and a record identifier (RIDₖ) that identifies the document (record) from which the statement is extracted. The tag identifier is determined as described below with reference to FIG. 4B. Typically a document will contain many different TIDs, and a TID may be associated with many different phrases within the record library. The phrases associated with any given TID may be identical, similar in wording and/or content, or different in content, meaning that the particular TID stands for more than one concept or idea.

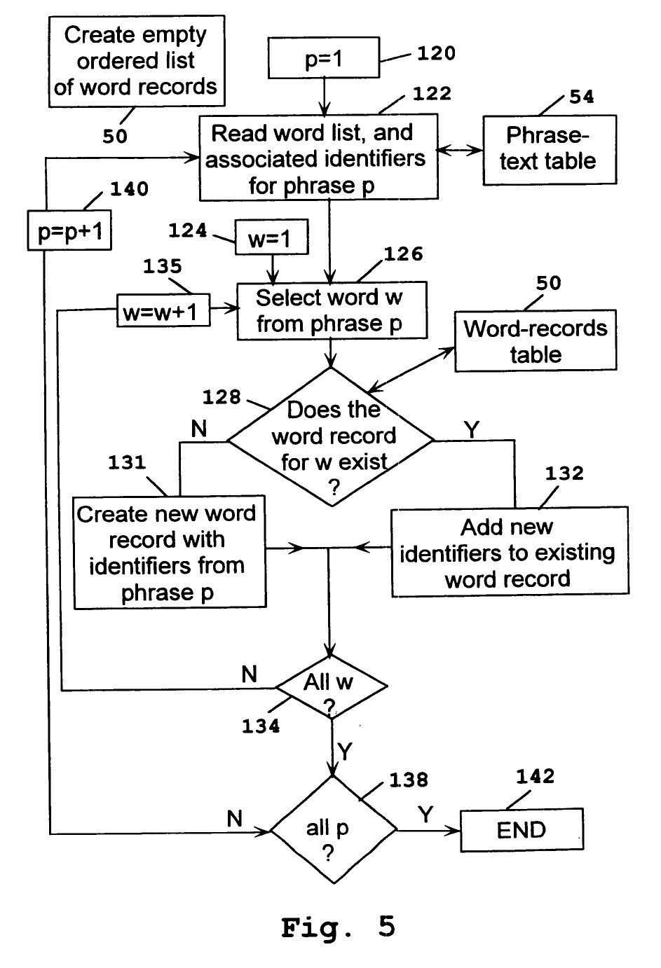

The phrase-ID table is used in generating a word-records table 50, according to the steps indicated at 66 in FIG. 2 and detailed below with respect to FIG. 5. The key locator for the word-records table is a phrase word, such as wordᵢ shown in FIG. 3B, and for each word, there is a list of all PIDs containing that word, and for each phrase PID, the TID with which the phrase is associated. As indicated in FIG. 3B, most words in the table will contain a relatively long list of phrase-lDs (PIDs) and associated tag IDs (TIDs). Preferably, the words in the table do not include generic words, such as common pronouns, conjunctions, prepositions, etc., as well as certain generic words that are common to a large number of phrases, such as (in the legal field) “legal,” “law,” “standard,” “test,” “court,” “fact finder,” “trial,” “on appeal,” appellate,” and the like (in the scientific field), such words as “study,” “experiment,” “finding,” “results,” “conclusion,” and “data,” and the like. As with the phrase-ID table, the TID associated with each PID in the word-records table is determined according to the method in FIG. 4B.

Returning to FIG. 2, the extraction program described in FIG. 4A also generates a tag-ID table 48, a portion of which is shown in FIG. 3C. The key locator in this table is the tag (e.g., citation) ID (TID), and the table contains, for each TIDᵢ, all of the document (record) IDs or RIDᵢ in the database that contain that citation, all of the statements PIDₖ associated with that citations, and the citation date (among other bibliographic information for that cite, such as author, journal or reporter, and volume and page number) for the cite, and the name of the client, i.e., client ID to whom or for whom the document was prepared.

As will be described further below, the RIDs for each tag are stored in the citation table as a number string composed of N digits, where each digit position in the string represents one of the N records, and that digit contains either a “1,” if the record corresponding to that index number contains the specific tag, or a “0” if it does not. Thus, an RID string for a given tag, e.g., citation, in the tag-ID table of the form “000010000110000110 . . . ” indicates that the tag is present in the records represented by index numbers 5, 10, 11, 17, 18, and so forth, and not present in those records where a “0” appears. This vector representation of records (where each string position represents a record component of the vector and the 0 and 1 values are the vector coefficients) allows for fast record comparison operations to be described below.

It will be appreciated that in constructing the above string representation of records, the program requires a temporary look-up file that lists the index position of each RID, so that the program knows which index position is associated with each RID. Then, in constructing the record-string entry for each tag in the tag-ID table, the program will record all RIDs containing that tag, from the look-up table, will determine the corresponding document-string index positions of all of those RIDs, and construct a string containing a 1 at all of index positions corresponding to the RIDs containing that tag.

Also as indicated in FIG. 2, the extraction program described in FIG. 4A also generates a record-ID table 52, a portion of which is shown in FIG. 3D. The key locator in this table is record ID (RID), and the table contains, for each RID, all TIDs of tags, e.g., citations, contained in that record, all PIDs of phrases contained in that record, and additional record information, such as record author and date.

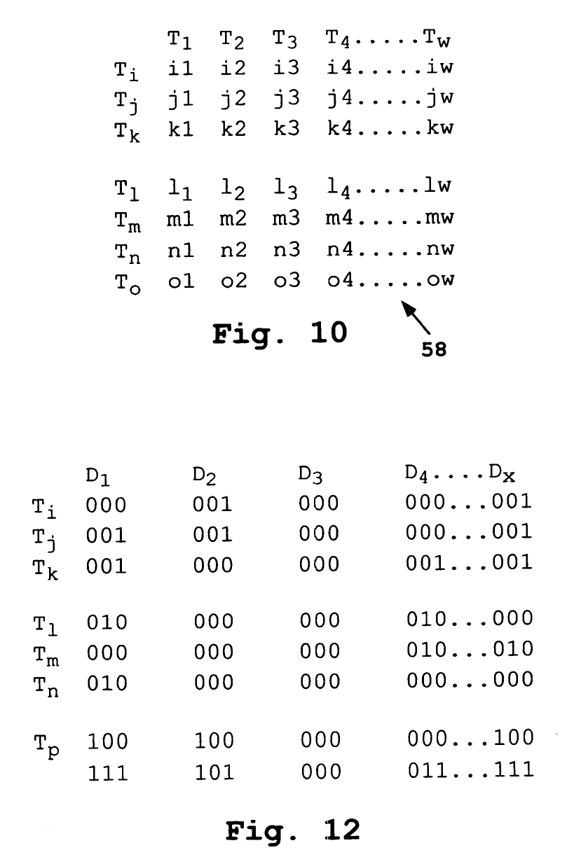

Also as seen in FIG. 2, the tag-ID table is used in creating a co-occurrence matrix 60. The co-occurrence matrix, a portion of which is shown below in FIG. 10, is a W×W matrix of W row tags, such as tags Tᵢ, Tⱼ, and Tₖ, times W column tags, such as tags T₁, T₂, T₃, and T_{w}, where the value of each matrix entry for a TᵢTⱼ matrix pair is the number of times the two tags Tᵢ and Tⱼ appear in the same record, normalized to a common value, e.g., such that the sum of all matrix values in a given row or column equals 1. The matrix is formed in accordance with the method described with respect to FIG. 6A and indicated at indicated at 68 in FIG. 2.

A related type of affinity matrix, referred to as a co-cluster matrix in FIGS. 1 and 2, is also a W×W matrix of matrix values for each pair of TᵢTⱼ tags in the matrix, and is formed in accordance with the method described below with respect to FIG. 6B.

FIG. 4A is a flow diagram of steps employed by the system in extracting tags, e.g., citations, and associated phrases, e.g., statements, from each of a plurality of citation-rich records, e.g., documents 62. For purposes of illustration, the documents processed in this example are legal documents, either opinions briefs or other documents generated by lawyers, or case-law decisions, e.g., appellate decisions published by court reporters. However, it will be appreciated from the following description how the system would be adapted for extracting citations and statements from other citation-rich documents, such as scientific or other scholarly works, or any other type of documents in which statements in the document are supported by reference citations. The application of the method to records having tags only or phrases only be considered further below.

The total number of records to be processed may be quite large, e.g., several hundred thousand citation-rich documents or more. Each record, as it is selected at 72 (with the counter initialized at 1 for the first record r, at 74) is assigned a new, next-up record ID, which will follow the record through the construction of the database tables.

For purposes of specific illustration, it is assumed that the record being processed is a patent-validity opinion, and that the particular passages the program first encounters are those Paragraphs 1-4 below, which will be used to illustrate the operation of the system in extracting citations (tags) and their corresponding statements (phrases):

[Paragraph 1] The presumption of validity of patent claims, like all legal presumptions, is a procedural device, not substantive law. However, it does require the decision maker to employ a decisional approach that starts with acceptance of the patent claims as valid and that looks to the challenger for proof of the contrary. Accordingly, the party asserting invalidity has not only the procedural burden of proceeding first and establishing a prima facie case, but the burden of persuasion on the merits remains with that party until final decision. TP Laboratories, Inc. v. Professional Positioners, Inc., 724 F.2d 965, 971, 220 USPQ 577, 582 (Fed. Cir. 1984); Richdel, Inc. v. Sunspool Corp., 714 F.2d 1573,1579, 219 USPQ 8 (Fed. Cir. 1983).

[Paragraph 2] The challenging party's burden also includes overcoming deference to the PTO's findings and decisions in prosecuting the patent application. Deference to the PTO is due “when no prior art other than that which was considered by the PTO examiner is relied on by the attacker.” American Hoist & Derrick Co. v. Sowa & Sons, 725 F.2d 1350, 1359 (Fed. Cir.), cert. denied, 469 U.S. 821, 83 L. Ed. 2d41, 205 S. Ct. 95 (1984). Conversely, no such deference is due when the party challenging the patent raises prior art or evidence that was not considered by the PTO in its decision and evaluation of the patent application:

[Paragraph 3] When an attacker simply goes over the same ground traveled by the PTO, part of the burden is to show that the PTO was wrong in its decision to grant the patent. When new evidence touching validity of the patent not considered by the PTO is relied on, the tribunal considering it is not faced with having to disagree with the PTO or with deferring to its judgment or with taking its expertise into account. American Hoist, at 1360.

[Paragraph 4] In Wang Laboratories, Inc. v. Mitsubishi Electronics America, Inc., 103 F. 3d 1571, 41 USPQ2d 1263 (Fed. Cir. 1997), the CAFC held that prosecution history attached where the patentee had claimed its invention with precision in order to distinguish over a plurality of prior-art references.

The first step in the record processing is to identify a citation, at 76. This is done, in the case of legal citations, by the program looking for certain words, abbreviations, and indicia that are common to legal citations. For example, the program might look for one of the following cues characteristic of a legal case name: “In re,” “ex parte,” or “v.” In addition, the program might look for the abbreviation for a state or federal reporter, such as “F.2d,” “F.Supp,” or “SCt,” or “USPQ”, all of which can be entered into a relatively small library of case reporters at the state and/or federal level. If a reporter name is found, the program could confirm by looking for numbers on either side of the reporter abbreviation. Finally, the case citation is likely to include the name of the trial or appellate court which handed down the decision, and the program can further confirm a citation by identifying a court abbreviation, such as “SCt,” “NDCa,” “Fed. Cir.”, and so forth, followed by a year, e.g., “1999,”, “2004.” indicating the year that the decision was published.

For example, the two citations in Paragraph 1 can each be identified by (i) a case name containing a “v.” (ii) the names of court reporters “F.2d” and “USPQ2d,”, (iii) a number preceding and following each court reporter, and (iv) a court name abbreviation and year of publication (typically in parentheses). The end of the first cite and beginning of the second one can be identified by one or all of (i) a semi-colon at the end of the first cite; (ii) the court name abbreviation and year at the end of the first cite, and (iii) a new case name at the beginning of the second cite. TP Laboratories, Inc. v. Professional Positioners, Inc., 724 F.2d 965, 971, 220 USPQ 577,582 (Fed. Cir. 1984); Richdel, Inc. v. Sunspool Corp., 714 F.2d 1573, 1579, 219 USPQ 8 (Fed. Cir. 1983).

Similarly, the sole cite in Paragraph 2 is identified by (i) a case name containing a “v.” (ii) the name of a court reporter “F.2d”, (iii) a number preceding and following each court reporter, and (iv) a court name abbreviation and year of publication (typically in parentheses. In addition, the subsequent appeals history of the case may follow the initial cite, this being distinguished from a separate citation by one or more of (i) lack of a semi-colon, (ii) lack of a new case name, and (iii) an abbreviation of the disposition of the appeal, e.g., “cert denied.” As above, the latter abbreviation is included in a “case-citation” abbreviations library that the program accesses during the operation of locating citations, the citation-finding step can small dictionary could is appeals a dictionary of suitable “American Hoist & Derrick Co. v. Sowa & Sons, 725 F.2d 1350, 1359 (Fed. Cir.), cert. denied, 469 U.S. 821, 83 L. Ed. 2d41, 205 S. Ct. 95 (1984).

It is common in a citation-rich document for reference to be made to a previously-referenced citation, and in this case, the citation may include simply a name in the case name followed by a comma the abbreviation of “supra,” meaning “above,” or “higher up” (in the document), “infra,” meaning “below” or lower (in the document) or “ibid,” meaning “in the same passage or citation,” or alternatively, a name in the case, followed by a comma, and the word “at” followed by a page number, referring to the page in the citation at which the referenced statement is found.

For example in Paragraph 3, the citation to “American Hoist, at 1360” is recognized by (i) a name in a case name already cited in the document, and (ii) “at” followed by a number. Similarly, the citation in the Paragraph 4 “Lockwood, supra” is identified by (i) a name in a case name already cited in the document, and (ii) a comma followed by the word “supra.” Of course, identifying previously cited references in any document requires that the program keep a list of cited case names during the processing of each documents, so that these can be compared with case-name abbreviations when one of the indicia of a previously cited case is encountered. Once a citation is encountered, it is extracted and placed in a file where the citation will be assigned a TID, as described below with respect to FIG. 4B.

As shown at 78 in FIG. 4A, the program then considers the sentence that immediately precedes the citation. If the sentence is a complete sentence, i e., begins with a capital letter and ends with a period or semi-colon or with a parentheses which give the citation, the sentence is extracted and assigned to the “statement” (phrase) for the citation or citations that it precedes, as a 84. Thus, for example, in Paragraph 1, the complete sentence that precedes each of the two citations is:

Accordingly, the party asserting invalidity has not only the procedural burden of proceeding first and establishing a prima facie case, but the burden of persuasion on the merits remains with that party until final decision.

Similarly, the sentence that precedes the single citation in Paragraph 2 is: Deference to the PTO is due “when no prior art other than that which was considered by the PTO examiner is relied on by the attacker.”

This preceding sentence is the statement or holding (or one of the statements or holdings) that will be assigned to the associated citation for the particular document from which the statements is extracted. As indicated at 84 in the figure, the sentence (statement or phrase) is extracted, assigned a phrase ID number at 94 (each statement is assigned a different, next-up number) and the phrase text is then stored, along with the PID and RID, at 96. Once the TID has been identified, as described below with respect to FIG. 4B, and indicated at 102 in FIG. 4A, the phrase ID (PID), tag ID (TID), and record ID (RID) are added to table 54 in constructing the phrase-ID table in the system.

If, during the processing of text that precedes a citation, an incomplete sentence is encountered, e.g., because a citation occurs in the middle of the statement, the partial sentence back to the beginning of the sentence may be used as the citation statement or the statement may be simply not processed, and the program will proceed to the next document citation, through the logic of 80, 82 in FIG. 4A.

Although not shown in FIG. 4A, the program may also encounter a third general case where the statement or phrase associated with a citation follows the citation. This case is illustrated in Paragraph 4 above, where a case name (citation) is followed by a general statement from that case. As will be appreciated from Paragraph 4, this general case can be identified by a distinctive syntax where a citation (1) begins a sentence, typically with the word “In”, and (2) the citation is followed by a text (statement) that ends the sentence.

As the program extracts sentences and citations, it also adds the PID and RID at 98 to an empty (or growing) record-ID table 52, and assigns the citation (tag) a TID at 102. The record-ID table may also receive author and date information as indicated above. The assigned TID is added to the record-ID table at 101, and to the phrase-ID table at 99. The TID is also added, at 104, as the key locator to an empty (or growing) tag-ID table 48, along with the associated RID, PID and tag date.

This processing is continued, through the logic of 86 and 82, until all citations in a document and associated statements have been identified, and all PIDs, associated phrase texts, TIDs, associated citations, RID, and other identifying information has been placed in the phrase-ID, tag-ID and record-ID tables, as just described. Each document is similarly processed through the logic of 88, 90, until all of the citation-rich documents in 62 have been so processed.

FIG. 4B is a flow diagram of the operation of the program in assigning new TIDs to each newly-identified tag, e.g., citation. After extracting a new tag, e.g., citation and its phrase, e.g., statement, at 84, as described above, the new tag, is compared at 106 with existing tags in tag-ID table 48. This comparing entails comparing each name in the new citation with each name in each of the existing cites in table 48. If a name match is found in any citation, the program compares the reporter information between the new and searched citation. If a reporter-information match is found, e.g., identical reporter and adjacent numbers, the two citations are considered identical. In this case, the “new” citation is assigned the number of the already-assigned tag, at 110, and that tag number is assigned to the various database tables. In particular, and as shown in the figure, the record ID from which the tag was extracted is added to the list of existing RIDs for that assigned TID in the tag-ID-table. If the newly-extracted citation is not already in the tag-ID table, the citation is assigned a new tag ID, placed as a new tag entry in the tag-ID table, and also added to the other database tables.

The citation-rich documents illustrated above illustrate records containing both tags (citations) and corresponding phrases (statements receding or following the citations). For some types of records the records may contain tags, but not phrases, as illustrated by patent documents containing classification information (tags), but no actual corresponding phrases. In processing patent-document records, the program looks for a classification field associated with the patent, and extracts each class/subclass number assigned to that patent document. Each of these class/subclass numbers becomes a tag associated with that patent, with each newly encounter class/subclass number being assigned a new tag-ID, and each already-extracted class/subclass being assigned the ID already existing for the class/subclass. To find the phrase associated with each tag, the program may simply look up the definition of that class and subclass in a classification definition index. This definition is then assigned to the corresponding class/subclass number, and becomes the phrase assigned to that tag. Thus, the phrase associated with each tag is retrieved from a source or concordance independent of the records themselves.

In other cases, the records may contain phrases, but not associated tags, in which case the program will assign a new tag ID to each new phrase. As an example, consider a library of records of disease states, where each record contains a number of descriptions of the symptoms (phrases) associated with the condition represented by each record. With each new symptom that is extracted from the records, the program will assign an existing tag ID if that symptom is identical to one previously extracted, and a new tag ID if the symptom (phrase) has not been previously extracted.

As another example, consider a library of records of a population group, where each record contains a plurality of descriptions of the personality traits or characteristics (phrases) associated with each person in the group. With each new trait or characteristic symptom that is extracted from the records, the program will assign an existing tag ID if that trait is identical to one previously extracted, and a new tag. ID if the trait (phrase) has not been previously extracted.

In either of the latter two libraries of records, each record in this library may be constructed as a group of tag descriptors (tags), where the phrases corresponding to the tags are stored in a separate “tag definition” file.

D. Generating a Word-Records Table and Affinity Matrices

As noted above, the program uses non-generic words contained in the extracted record phrases to generate a word-records table 50. This table is essentially a dictionary of non-generic words, where each word has associated with it, each PID containing that word, and optionally, for each PID, the corresponding TID for that statement.

In forming the word-records file, and with reference to FIG. 5, the program creates an empty ordered list 50, and initializes the PID to p=1, at 120. The program now retrieves phrase 1 (PID₁) from the phrase ID at 54, and stores a list of non-generic words in that phrase, and also reads in the associated identifiers for that phrase, at 122, that is, the associated TID and RID. With the word number initialized at 1, the program selects the first word w in phrase p, and asks, at 128, is word w already in the word-records table. If it is, the word record identifiers (associated PID and TID) for word w in phrase 1 are added to word-records table 50 for that word in the table, at 132. If not, a new word entry is created in table 50, at 131, along with the associated PID and TID identifiers. This process is repeated, through the logic of 134, 135, until all of the non-generic words in phrase p have been added to the table. Once a statement has been processed, the program advances, through the logic of 138, 140, until all phrases in the phrase ID table have been processed and added to the word-records table, terminating the processing steps at 142.

In one exemplary embodiment, every verb-root word in a phrase is converted to its verb root; that is, all verb-root variants of a verb-root word are converted to a common verb-root word in the word-records table.

The system also may include one or more “tag affinity” matrices used in various system operations to be described below. As used herein, “tag affinity matrix” refers to a N×N matrix of N tags, where each i×j matrix value indicates the affinity of tags i and j in records from which the N tags are extracted. This section considers two exemplary affinity matrices: (i) co-occurrence matrix 58 whose matrix values are the normalized number of record co-occurrences of each pair of tags, and (ii) co-cluster matrix 60 whose matrix values indicate the extent to which each pair of tags co-cluster with all other N tags.

FIG. 6A is a flow diagram of steps employed in the system for generating co-occurrence matrix 58. As noted above, this is an N×N matrix of all N tags, where each i×j term in the matrix is the number occurrence of all records in the system that contain both TIDᵢ and TlDⱼ, where the matrix values have been normalized to 1, that is, the matrix values have been adjusted so that the sum of all of the matrix values for a given citation in a matrix column (or row in some cases) is one. To construct the matrix, Tᵢ is initialized to i=1 (150), and the program selects at 152 citation T₁ from the tag-ID matrix 48, as indicated at step 152, and retrieves all of the RIDs for that TID, at 154. A second tag count at 158 is set at j=1 for tags Tⱼ, and a second tag Tⱼ is selected from table 48. If Tⱼ is the same as Tᵢ, the program advances to the next Tⱼ, through the logic of 161 and 166, and a zero is placed at the Tᵢ×Tᵢ matrix position (on the matrix diagonal). If Tᵢ and Tⱼ are different tags, the program retrieves all documents for Tᵢ, at 162, and then counts the number of documents (RIDs) that contain both Tᵢ and Tⱼ. This “co-occurrence” value is added, at 168, to matrix 58.

This process is repeated, through the logic of 164, 166 until all Tᵢ×Tⱼ co-occurrence values have been determined for the selected tag Tᵢ. The program now proceeds to the next tag Tᵢ₊₁, through the logic of 170, 172, until the matrix values for all N tags have been determined, at 174. The matrix values for each column row may now be normalized to a sum of 1, as indicated above.

The co-cluster matrix is generated in accordance with the steps shown in FIG. 6B. This matrix is also an N×N matrix of all N tags, where each i×j term in the matrix is indicative of the extent to which tags Tᵢ and Tⱼ co-cluster with other citations in the system. To construct the matrix, Tᵢ is initialized to 1 (151), and the program retrieves from the co-occurrence matrix 58, the Tᵢ row of co-occurrence matrix values from matrix 58, at 153. A second citation Tⱼ count 155 is set at 1 and a second tag Tⱼ is selected from matrix 58. As above, if Tⱼ is the same as Tᵢ, the program advances to the next Tⱼ, through the logic of 175, 167 and a zero is placed at the Tᵢ×Tᵢ matrix position (on the matrix diagonal). If Tᵢ and Tⱼ are different tags, the program retrieves, at 157, the Tⱼ matrix row from matrix 58. The two matrix rows (vectors) Tᵢ and Tⱼ are then aligned, at 159, for vector-term cross-correlation, at 163. The cross-correlation operation is intended to quantify the extent to which the two vectors Tᵢ, and Tⱼ have similar co-occurrence values with all other N citations. This can be done, in one exemplary operation, in a term by term fashion in which, for each term (tag) of the two aligned vectors, a coefficient correlation value is calculated in the following way: (1) If either of the coefficients for a term is below a selected threshold, e.g., 0.05 of the largest co-occurrence value in matrix 58, the coefficient correlation value for that term (tag) is assigned a zero value; (2) if both of the coefficients are above this selected threshold, the coefficient correlation value is calculated as xᵢ+xⱼ/|xᵢ-xⱼ|, where xᵢ and xⱼ are the coefficients of term x in the Tᵢ and Tⱼ matrix-row vectors. As seen, this function measures the extent to which any term has high and substantially equal co-occurrence values. When these correlation values have been calculated for each term x of the vectors, the correlation values for all vector terms are summed, yielding the co-cluster matrix value for the tag pair Tᵢ×Tⱼ, which is added in box 177 to the co-cluster matrix 60.

This operation is repeated for each of the Tⱼ tags, through the logic of 165, 167, to fill in the co-cluster values of all each term in tag row Tᵢ in the matrix. The operation is then repeated for each Tᵢ, through the logic of 169, 171, until all of the co-cluster matrix rows have been filled in, at 173.

The co-cluster matrix can, in turn, be used to generate a cluster matrix which is a matrix of N tags by M tag clusters. In one method, the program first operates to find, for each tag, all other tags that tend to group with that tag, that is, all tags whose co-cluster values within a given tag row are above a selected threshold value. These initial groups will be referred to as tag clusters. Once this is done, the program compares the individual tag clusters for those that have substantial tag overlap. For example, the program may combine two tag clusters if more than 90% of their tags are common to one another, and this process may be repeated, using successively lower overlap values, e.g., 80%, then 70%, and so on, until some defined number M of clusters, e.g., 25-50 have been generated. In any tag group thus generated, the matrix value of a given tag may be assigned to “1” meaning the tag is in that cluster or it may retain the actual co-occurrence value from the original co-occurrence.

The next step is to place all tags in the best cluster or clusters. This will involve assigning all as-yet-unassigned tags into one or more existing clusters and may additionally involve placing some already-assigned tags into one or more different clusters. To carry out this step, an average cluster score is calculated for each tag against the tags in each of the M clusters, by adding the total co-cluster matrix values for that tag against all tags in a given cluster, and dividing by the total number of tags in that cluster. The tag is then assigned to the cluster for which the largest average cluster score was calculated. If a tag cluster score is below a certain threshold, it may left unassigned, as not belonging to any cluster. Once this initial assignment is made, the program may assign individual tags in one of the M clusters to any other or additional cluster for which that tag cluster score is higher, e.g., 1.5 higher, than the lowest cluster score in that cluster.

E. User-Directed, Phrase-Based Searching

This section considers the operation of the system in finding a phrase and/or a record of interest to a user, by phrase-based searching. As will be appreciated from the search procedures described below, the phrases represent a content-rich shorthand to the subject matter of a record, providing a plurality of content “hooks” to a phrase-rich or tag-rich record. In addition, the search procedure can be exhaustive in the sense that the user can continue to add different-content search queries until a desirably small number of “candidate” records are found. Although the method and system operation will be described with respect to finding legal citations and documents, based on user-input legal statements or holdings, it will be appreciated how the method and operation apply to searching for any type of citations and citation-rich document, e.g., scientific articles, or other scholarly works. The operation of the program in retrieving other types of records that contain either tags or phrases, but not both, will be described below.

In general, a search for a desired record, e.g., document, involves, from the user's point of view, finding a record containing a number of different tags that represent each of a number of different phrases, e.g., legal holdings. That is, the user searches for record(s)—in this example, legal documents—containing each of a number of different holdings or statements, based on the presence in the document(s) of each of a number of corresponding citations. Since a record-retrieval search involves finding each of a plurality of different citations, this section first considers the method by which a citation (tag) of interest can be searched by a user. That is, the search for a citation may be an end in itself, or the first step in record-retrieval search.

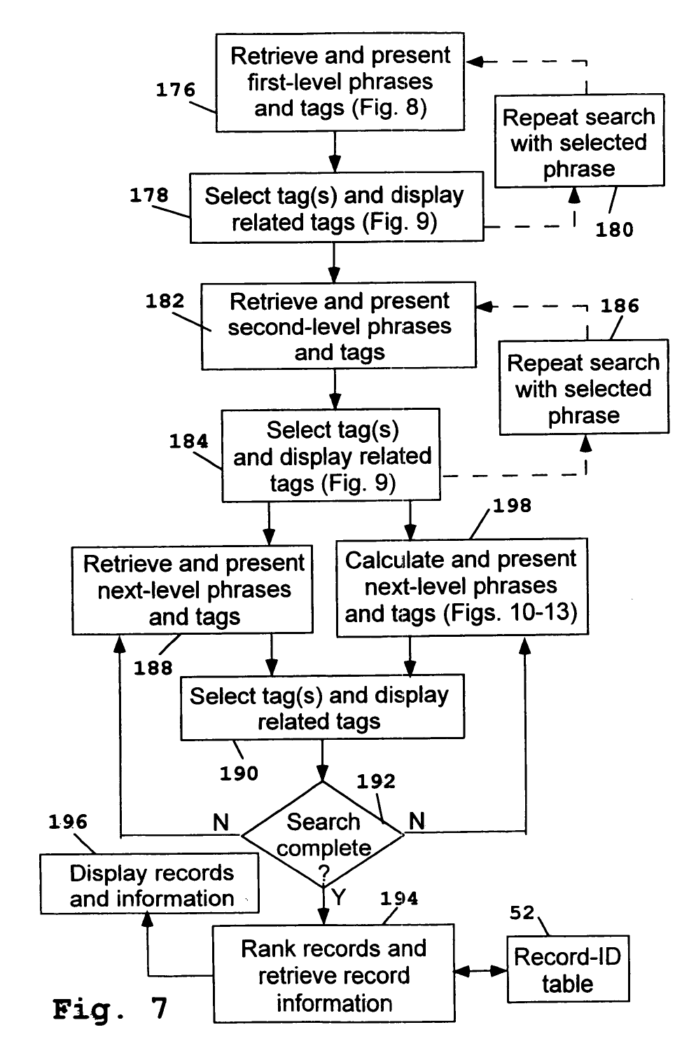

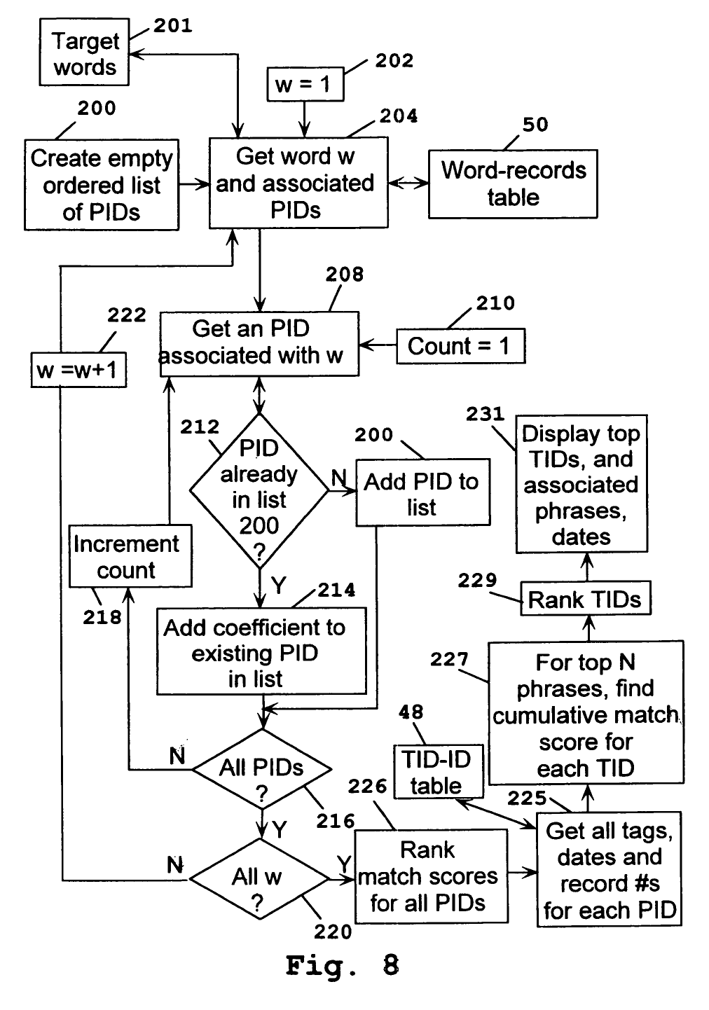

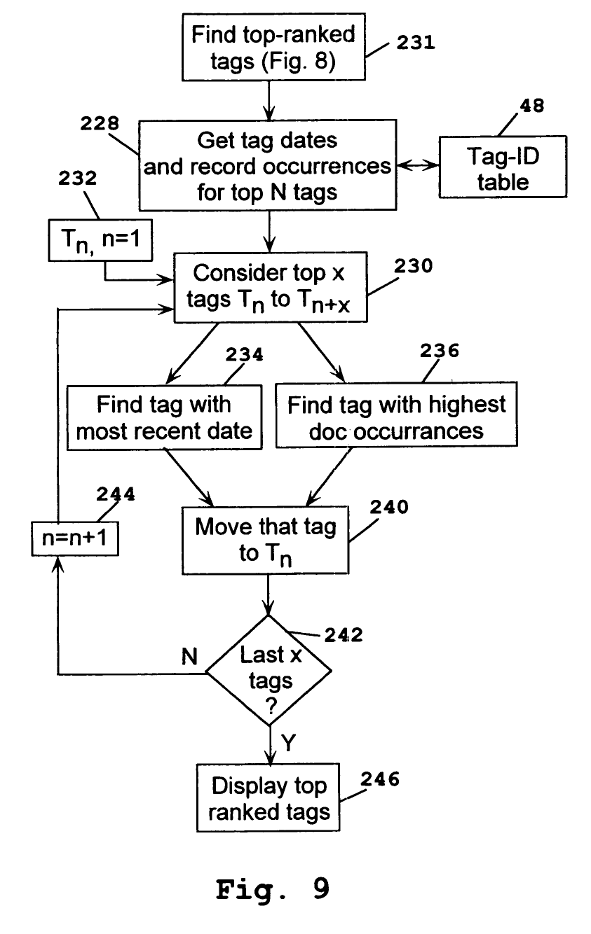

Individual citations (tags) are identified and selected, in accordance with one aspect of the invention, by the user entering a word query that approximates a statement (phrase) of interest, e.g., a legal holding or proposition, or contains key words that are associated with the statement of interest. The system then searches the database and returns phrases that have the closest (highest-ranking) word match with that query, along with pertinent tag information associated with that statement. These steps are shown at the top in FIG. 7, and described below with respect to FIG. 8, where box 176 represents an initial user query, the statement search, and display of the highest-matching statements and associated cites.

In box 178, the user may ask the program to display cites (tags) ranked either by phrase word-match score, by citation date, or by number of records that contain the cites, as described below with respect to FIG. 9. The user reviews the phrases presented, and may either select one or more phrases from the display, or select one of the displayed phrases as a more representative or robust target for the desired citation, and rerun the search, as indicated at 180. The latter, iterative approach allows the user to make an initial rough guess at the wording of a desired phrase, then refine that query by using a representative phrase actually contained in the system. At this stage, the system can display the search results in a variety of ways, depending on user selection: For example:

1. A display of all the top-ranked phrases, including phrases that may be associated with the same tag.

2. A display of the top-ranked phrases for each tag; In this mode the program scans through the ranked phrases, takes the top-ranked phrase for each different tag and presents this phrase and the corresponding tag, i.e., only one phrases per tag.

3. A display of top-ranked phrases and tags, arranged to place the most recent citations first (see below); and

4. A display of top-ranked phrases and citations, tags, arranged to place the tags with the highest record occurrence first.

At this point, the user can select one or more particular tags of interest, and further request a display of all phrases corresponding to a given tag. This, along with the tag date and court, will provide the user with a basis for deciding if any one tag is a desired one. For example, in reviewing all of the statements associated with a given citation (tag), the user may decide that the tag holding is actually contrary to the holding being sought. It can be appreciated displaying all of the phrases associated with a given tag gives the user a relatively complete overview of the pertinence of that tag.

Assuming that the search is intended to locate a record of interest, the user will typically select two or more tags at 178 that are substantially equivalent in a desired holding (phrase), with the idea that the record being sought may have any one or more tags with equivalent-content phrases. The two or more selected tags thus serve as “synonyms” of each other with respect to the user query.

The user now proceeds to a second level of search, beginning at box 182, where one or more tags associated with a different-content phrase will be displayed and selected. The three boxes for this second level, indicated at 182, 184, and 186, encompass the same system operations represented by boxes 176, 178, and 180, respectively. The display at the second level may also include a record-number display that indicates to the user, for each tag presented, the number of records in the system containing one or more of the selected tags from the first level and the displayed second-level tag. If this number is small enough, the user can request a display of the record IDs containing the identified citations. If not, the search is continued until enough different tags (or groups of tags, each corresponding to a given phrase) have been identified for the system to identify a desirably small number of records for the user to review. As with the first stage display, the user may select two or more tags with similar or equivalent phrases, to enhance the possibility of finding a record with that phrase, e.g., general case holding.

At any stage in the search method after the first stage, but typically after the second or third stage, the user can switch to a system-directed, autosearch mode in which the system uses mined information from the documents to identify additional tags that (i) are associated with tags already selected by the user, e.g., in the first two stages of the search, and (ii) limit the total number of records within the scope of the search in a systematic way. The selection of either user-directed or system-directed mode is illustrated in the bifurcated steps found in the middle of the flow diagram, where the box 188 indicates the search for an additional user-directed level of tags, and box 198 indicates a system-directed search for additional tags. In either case, the user will select one of more of the tags displayed from this next stage of the search (box 190), and the system will indicate, as part of the display, the total number of records containing one or citations from each level of search. The operation of the system in the “system-directed” mode will be described below in Section F with reference to FIGS. 10-13.

If the number of records identified by the search at this stage is suitably small, e.g., less than 5-20 records, so that the records identified can be assessed without unreasonable effort, the search will be complete, as at 192, in which case the system will rank the documents according to tag match score, and/or date, at 194, by accessing record-ID table 52, and display the results to the user at 196. Otherwise, the search process will be iterated to one or more additional stages, either in the “user-directed” or “system-directed” mode, until a suitably small number of records are identified.

FIG. 8 illustrates the operation of the system in finding the highest-ranking phrases in the system, in response to a user-supplied phrase query (boxes 176 and 182 in FIG. 7). As a first step in the search, the program converts the user query, which can include either a user-input phrase or a user-selected phrase (boxes 180, 186 in FIG. 7), into a search vector. The search vector may be composed of word and optionally word-pair terms, and for each term, a coefficient that indicates the weight that term is to be given, relative to other terms in the vector. In one embodiment, the vector terms are simply all of the non-generic words contained in the paragraph summary, with each word being assigned a coefficient value of 1. In this embodiment, the program simply reads the paragraph summary, extracts non-generic words, converts verb words to verb-root words, and assigns each term a coefficient of 1. If a more refined search is desired, the program may operate to extract both non-generic words and proximately formed word pairs in constructing the search vector, and assign to these terms either the same coefficient, e.g., 1, or a coefficient related to the term's selectivity value and inverse document frequency (IDF) (in the case of word terms), as described in co-owned fully in co-owned published PCT patent application for “Text-Representation, Text Matching, and Text Classification Code, System, and Method,” having International PCT Publication Number WO 2004/006124 A2, published on Jan. 14, 2004, which is incorporated herein by reference in its entirety and referred to below as “co-owned PCT application.”

Although not shown here, the vector may be modified to include synonyms for one or more “base” words in the vector. These synonyms may be drawn, for example, from a dictionary of verb and verb-root synonyms such as discussed above. Here the vector coefficients are unchanged, but one or more of the base word terms may contain multiple words, again as described in the above co-owned PCT patent application. The target words and coefficients are stored at 201 in FIG. 8.

As indicated above, the search operates to find the phrases stored in the phrase-ID table having the greatest term overlap with the target search vector terms. Briefly, an empty ordered list of PIDs, shown at 200, stores the accumulating match-score values for each PID associated with the vector terms. The program initializes the vector term (e.g., word) at w=1 (box 202) and retrieves (box 204) the first word and associated coefficient from target words 201 and retrieves all of the PIDs associated with that word from word-records database 50. With the PID count set to 1 (box 210), the program gets a PID associated with word w (box 208). With each PID that is considered, the program asks, at 212: Is the PID already present in list 200? If it is not, the PID and the term coefficient for word w are added to list 200, creating the first coefficient of the summed coefficients for that PID. (For the first word of the search vector (w=1), each PID will be newly added to the list.). If the PID is in list 200, the program adds the word coefficient to the existing PID in the list, at 214. This procedure is repeated, through the logic of 216 and 218 until all PIDs for word w have been considered and added to list 200. The program then advances to the next search word, through the logic of 220, 222, and the process is repeated for all PIDs associated with that word.

When all of the words in the search vector have been considered (box 220), the program adds the coefficient scores for each PID, and ranks the PIDs by match score, at 226. By accessing tag-ID table 48, the program gets all tags, dates and record occurrence (number of records containing that cite) for the N top-ranked phrases, for example, all phrases whose match score is at least 75% of a perfect match score, as indicated at 225. For these top N phrases, the program finds a cumulative match score for each TID, at 227, and ranks these TIDs by total match score at 229. The user can elect to see the tags and the associated phrases displayed by total match score, by match score ranked by tag date or match score ranked by record occurrence.

The system operation in carrying out the latter two displays will now be considered with reference to FIG. 9. For each tag displayed, the program can also display the top-ranking phrases associated with that tag.

The purpose of the ranking operations shown in FIG. 9 is to re-rank the tags, previously ranked according to total phrase score, according to tag date or record occurrence of that citation, i.e., number of records containing that citation. The re-ranking is done by a moving window method that considers, at any one time, a small window of X ranked tags, where X is typically 5-10. Within this window, the most recent tag (where the tags are being ranked by date) or the tag with the highest record occurrence (where the tags are being ranked by document occurrence) is moved to the top of the ranking within the window, and the window then moves “down” one tag, and repeats the process of moving the tag with the top-ranked date or record occurrence to the top of the new X-tag window. Thus, a tag can advance in ranking by X tags at most, so that the final rankings reflect both by total tag score and tag date or tag record occurrence.

Box 231 in FIG. 9 shows the top-ranked tags obtained from each stage of a user-directed search, as described above. Accessing tag-ID table 48, the program gets the tag dates and record occurrences for these top-ranked TIDs, at 228. The program is initialized to tag cₙ, n=1, where n represents the rank of the ranked tags and n=1 indicates the top-ranked tag (box 232). As indicated at 230, the program considers the top X tags, that is, Cₙ to C_{n+X}, where X is typically 5-10 (box 230). If the tags are being ranked by tag date, the program finds the most recent tag within this window, as at 234, where tag dates may be determined by one or more of (i) year of tag, (ii) month and year of tag, if available, and (iii) volume of reporter or journal, if the same for two different tags. The most recent tag is then moved to the top of the rankings within the window, e.g., become or remains c₁ for the first window position (box 240).

Similarly, if the re-ranking is being carried out on the basis of record occurrence, the program finds the tag with the highest record occurrence within this window, as at 236, where record occurrence is determined by adding the documents associated with each tag in the tag-ID table. The most heavily cited document is then moved to the top of the rankings within the window, e.g., become or remains c₁ for the first window position (box 240).

This process is repeated for each successive X-citation window, through the logic of 242, 244, until the window spans the last X citations in the ranked list. The newly ranked citation listed, re-ranked to favor either citation date of document occurrence, is then displayed at 246. As above, the citation may be displayed along with its date, document occurrence value, and top-scoring statement.

The above description applied particular to a user-based word search for citation-related statements (phrases) contained in legal or scientific documents, where (i) each phrase and associated citation (tag) are contained in the document (records) being searched records, and (ii) any one citation (tag) may be associated with many different phrases.

In applying the method to retrieving patent documents (records), the phrase-ID table will consist of a list of phrase identifiers (the key locator), and for each phrase ID, the text of a patent classification definition, and the corresponding class/subclass numbers (the tag). The word-records table will consist of a list of all non-generic words contained in the classification definitions, and for each word, the phrase ID of all classification definitions containing that word, and for each phrase ID, a corresponding tag (classification number ) ID. A user-directed word search, then, will yield a list of patent classification definitions, ranked by word-match score, and displayed along with the corresponding classification numbers, and/or along with information about the total number of records containing having that assigned classification number.

As noted above, the method may also be applied to retrieving records of the type characterized by a set of properties of traits that are assigned to the different individuals or objects associated with each record. For example, the records may relate to individuals in a website database, e.g., a match service website, where each individual record contains a list of personality or preference traits, or the records may relate to disease conditions or states, where each record contains a list of symptoms (phrases) associated with that state. In this general case, a user-directed search will yield a list of phrases, e.g., personality traits or disease states, ranked by word-match score, and displayed along with information about the number of records associated with each symptom.

F. System-Directed Statement-Based Citation Presentation

This section considers the system-directed or autosearch feature of the operation of the invention in finding and presenting to the user tag and/or phrase information that will guide the user finding records of interest. As will be seen, one purpose of this feature is to present to the user, phrase choices that may not otherwise have occurred to the user during a search for a record of interest. Another purpose is to guide the user selection, at each phase of the search, in a way that allows the user to select phrases that are meaningful in the record search, but at the same time, do not overly limit the subset of records being considered.

In overall operation of the autosearch feature, the user will select at least one, preferably at least two groups of tags, e.g., one group from separate user-directed search, as discussed in the section above. Using these groups of already selected tags, the system will find and present new tags (or associated phrases) frequently associated with those tags (or phrases) already selected. For purposes of illustration, it will be assumed that the user has carried out first- and second-stage selections for tags, e.g., citations from legal documents, as described above, and selected first-stage tags tᵢ, tⱼ, and tₖ and second-stage citations tₗ, tₘ, tₙ, and tₒ. As just indicated, one purpose of the system-directed method in this example is to use these two groups of selected citations to guide the user toward a desired search document(s), by one or more system-directed search stages.

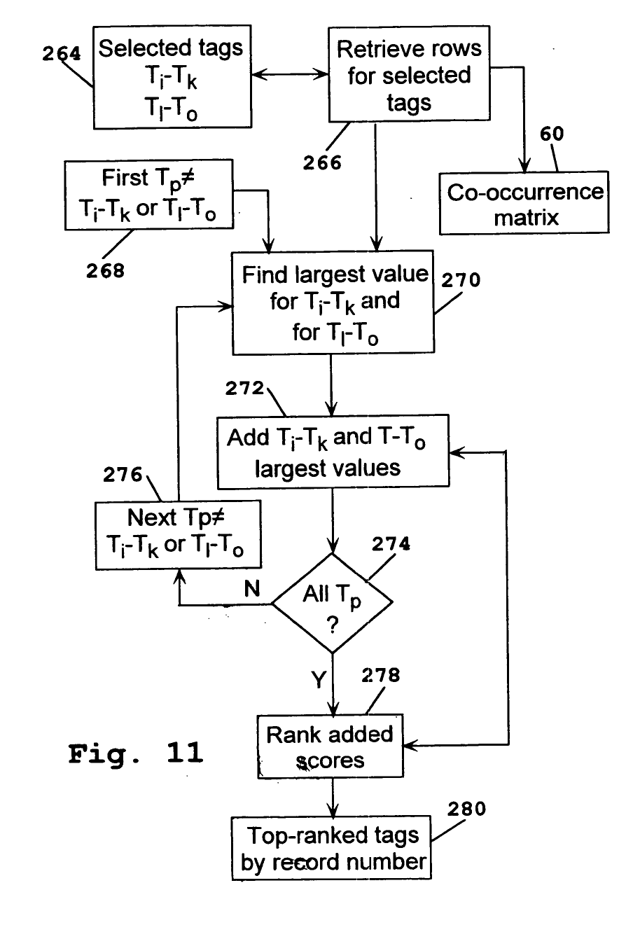

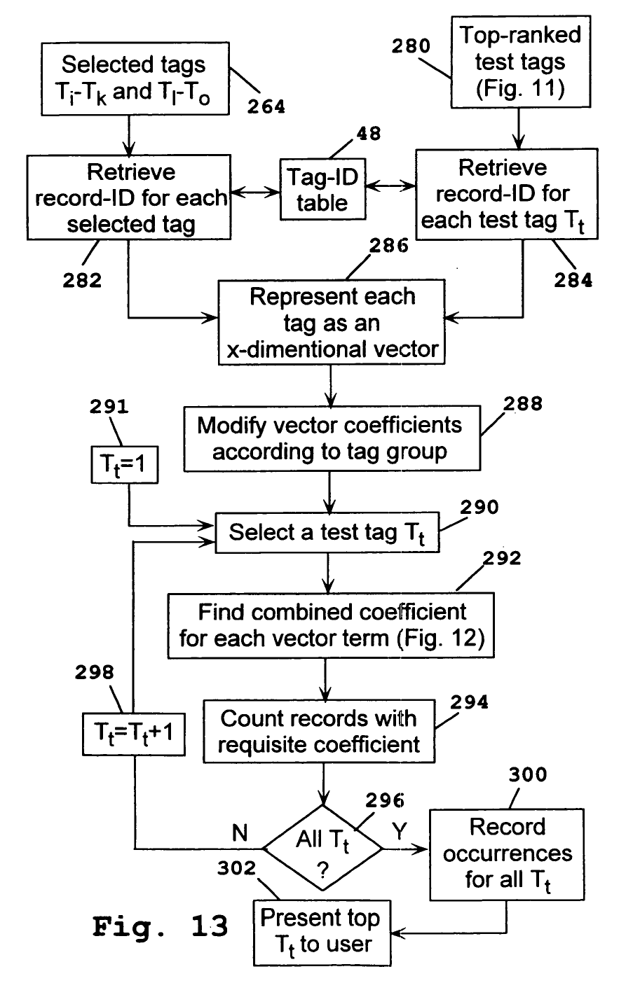

The system-directed method has two separate operations. In the first operation, described below with respect to FIGS. 10 and 11, the program uses data from co-occurrence matrix 58 to find tags that are likely to co-occur with the already selected tags, based on their co-occurrence values with the selected tags. In the second operation, described below with respect to FIGS. 12 and 13, the system calculates the number of records containing one or more tags from the user-selected tag group or groups, and one of the “test” tags from the first operation. These test or trial tags are then presented to the user, ranked by order of document occurrence, to prompt or guide the user toward records of interest.

FIG. 10 shows a portion of co-occurrence matrix 58 that includes the matrix rows for the tags tᵢ, tⱼ, and tₖ selected from the first search stage in this example, and the matrix rows for the tags tₗ, tₘ, tₙ, and tₒ.from the second stage in the example. Each row includes w co-occurrence values “ip”, the calculated occurrence of tag “i” and tag “p” in the records of the system. The tags selected from the previous two stages of search are indicated at 264 in FIG. 11. The program accesses co-occurrence matrix 58 to retrieve the matrix rows for these tags, shown FIG. 10. Operationally, the program may retrieve rows tᵢ, tⱼ, tₖ, tₗ, tₘ, tₙ, and tₒ from the matrix and place these rows in the active memory of the program. The citation“columns” t₁ to t_{w} in FIG. 10 are initialized to the first citation tₚ in a row that is not one of the selected citations, at 268. The next step is to find for that tag (tₚ) column, the largest co-occurrence value in each group of selected citations, at 270. For example, if the first tag column selected is t₁ in FIG. 10, the program finds the largest value among “i1,” “j1,” and “k1,” and the largest value among “l1,” “m1,” “n1,” and “o1.” These largest values are added, at 272, and the sum stored for that column tag. Alternatively, the program may find the average values of “i1,” “j1,” and “k1,” and the average value of “l1,” “m1,” “n1,” and “o1,” and add the two average values and store this sum for that column citation. This process is then repeated, through the logic of 274, 276, for the next column tag that is not one of the selected tags. If this next tag is, for example, t₂, the program finds the largest values among “i2,” “j2,” and “k2,” and among “i2,” “m2,” “n2,” and “o2” in FIG. 10, adds the two largest values and stores the sum for that column tag, or alternatively, finds the average value of “i2,” “j2,” and “k2,” and the average value of “i2,” “m2,” “n2,” and “o2”, adds the two average values and stores the sum for that column tag . This process is repeated, at 274, 276, until all tags have been considered. The tag scores are then ranked, at 278, and the top X, e.g., 50-200 tags are selected at 280, completing the first operation of the process. It will be recalled that the co-occurrence values in the co-occurrence matrix are preferably normalized, e.g., so that the sum of values in each column is one, so that the values computed for each column in the method above is based on relative co-occurrence values, not absolute ones.

In the second operation, the record IDs associated with each of the previously selected tags, indicated at 264 in FIG. 13, and each of the top-ranked test tags 280 from FIG. 11 are used to find the number of records containing one or more tags from each of previously selected groups of tags and a selected one of the test tags. The system first accesses tag-ID table 48 to retrieve the record IDs associated with each of the previously selected tags in 264 (box 282) and each of the top-ranked test tags in 280 (box 284). The entire matrix may be retrieved or only selected rows in the matrix corresponding to the selected tags and test tags. As discussed above, each record list for each tag in the tag-ID table is represented as a string of N binary digits, where N is the total number of records, each string position represents a given RID, and the digit at any index position represents the presence (“1”) or absence (“0”) of the corresponding tag in the record for that record position.

In one embodiment, illustrated in FIG. 12, the record string is further processed so that each string position is expanded to a multi-digit coefficient whose digits are related to the number of previous queries. Briefly, the coefficients assigned to the vector terms (index position corresponding to document numbers), at 288, will depend on the group of tags that any particular tag belongs to. In the present example, the system has three tag groups to consider: (i) the first selected group of tᵢ, tⱼ, and tₖ,(ii) the second selected group of tags tₗ, tₘ, tₙ, and tₒ, and (iii) one of the test tags from FIG. 11, shown as a separate group in FIG. 12.

For three groups of tags, the system will need three digits or bits to distinguish various combinations of the groups. As shown in FIG. 12, the first group is assigned coefficients of 001 or 000, depending on whether the associated record contains (001) or doesn't contain (000) that tag. For the second group of citations, the identifying bit is in the second position; thus, coefficient of 010 or 000 depending on whether the associated document contains (010) or doesn't contain (000) that citation. Each cite in the test group is similarly assigned vector coefficients of 100 or 000 to denote the presence or absence of the citation in a given document. The coefficient assignments are indicated at 288 in FIG. 13.

With the test citations ct initialized to 1 (box 291), the program selects a test citation cₜ, and finds the combined coefficients for each vector term among the three groups of citations. With reference to FIG. 12, this step can be carried, at each vector term (document ID), by separately inspecting each digit, starting with the right-most digit, and asking: does the column contain any “1” values, ie., combining the coefficients by an “or” operation. If it does, the middle column of digits is then inspected, and the same question asked. If again a 1 is found, the program looks at the right-most column, and asks the same question again. If again a “1” value is found, that term (document ID) has a score of “111,” indicating that the document contains at least one citation in each of the three groups tested. When a zero is encountered at any of these steps, the program advances to the next vector term (document ID) without needing to complete the inspection of each column of digits for that coefficient. These steps, which are generally at box 292 in FIG. 13, are repeated for each vector term (document-ID) in the vector, e.g., documents D₁ to Dₓ in FIG. 13. When all vector terms have been considered, the program counts the terms with the requisite “111” coefficients, at 294, to determine the number of documents containing at least one citation from each of the first two selected-cite groups and the test cite ct under consideration. These steps are repeated for each of the test cites ct, through the logic of 296, 298.

In an alternative method, the citation-document strings from the tag-ID table are used directly to calculate a document-number score for each of the selected citations. This can be done in two steps, as follows: In the first step all of the document strings for the selected tags from each given search group, e.g., the first selected group of tags tᵢ, tⱼ, and tₖ, or the second selected group of tags tₗ, tₘ, tₙ, and tₒ, are combined by an OR operation of the document strings for that group. Thus, in the case of the tags tᵢ, tⱼ, and tₖ, the three record strings for these tags are combined so that a 1 value is assigned at each record position at which at a given record is present for at least one of the three tags, producing a “group” record string for each group of tags so considered.

Once these group record strings are generated, one for each previously selected groups of tag, the group strings are tested with each test tag string to determine the number of records containing at least one tag from each of the previously selected tag groups and the test tag. This can be done by combining the group tag strings and a test tag string by an AND operation whose effect is to generate a 1 value for a given record only if that document is present in each of the group tags strings and in the test tag string. Once all of the record positions have been considered, these individual record “AND” scores are simply added to determine the total number of records containing at least one of the tags from each of the previously selected citation groups, and the test citation.

At the end of this operation, the program has calculated the number of records containing at least one tag from each group of previously selected tags and test tag tₜ, as at 300. The test tags are then ranked according to this number-of-records value, and presented to the user in rank order, as at 302. In one exemplary method, the system uses the co-occurrence matrix to find the top 200 co-occurring tags (the test tags), calculates the record score for each test tag, and presents the top 50 tags, ranked by record score, to the user. As will be seen below, a tag is typically presented in this context as the tag itself (e.g., as it is cited in a document) including tag date, the number of records containing that tag (and at least one of each previously selected groups of tags), and a phrase associated with that tag. This phrase may be, for example, 3-5 representative statements selected at random for a given citation from the citation-ID table.

If a desirably small group of records are shown for a particular tag, the user can choose to view each of the identified records. On command from the user, the program will show the user the different identified records, display each by record identifiers such as title, author, and date, and tags and corresponding phrases statements associated with that record.

If the user wishes instead to reiterate the system-driven search, the citations just selected become the next group of selected citations, and the program repeats the above steps, using now three selected groups of citations to (i) identify additional citations having a high co-occurrence with at least one citation in each of the three selected citation groups, and (ii) to identify test citations that preserve the most documents, in combination with the three selected citation groups. A typical search and displayed results will be given in the section below.

F1. Application to Citation-Based Document Searching

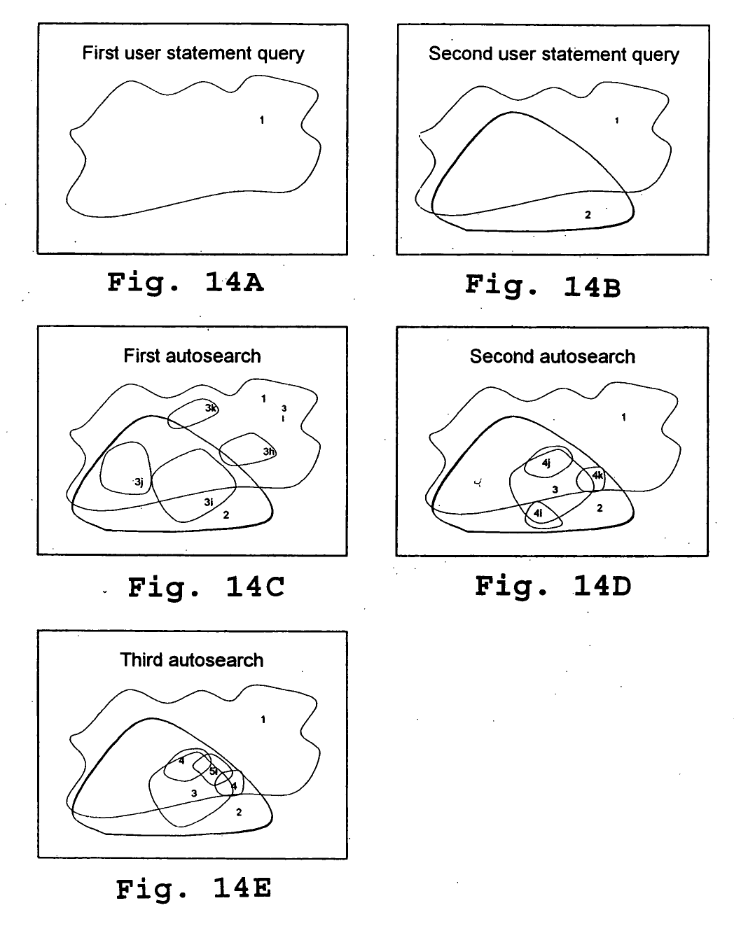

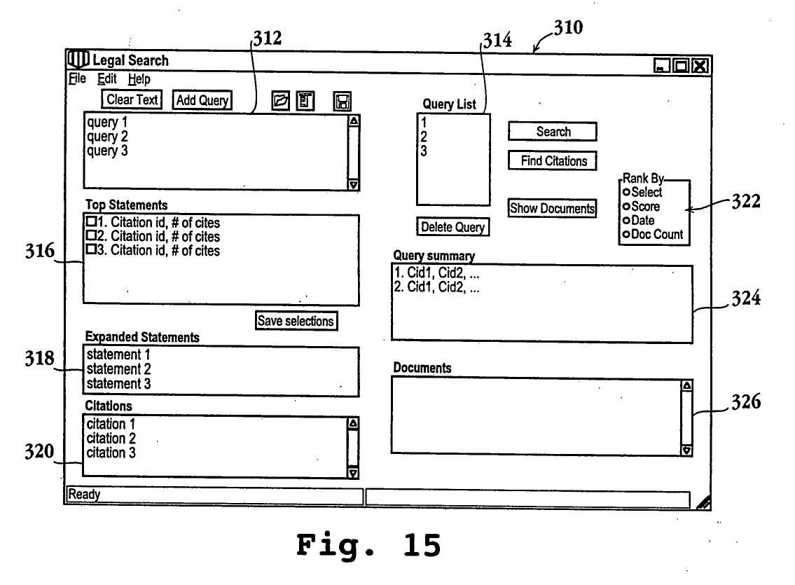

FIGS. 14A-14E illustrate, in Venn-diagram form, how the system-directed search mode of operation functions to assist the user in finding one or a few pertinent records containing a group of selected propositions or statements. In the first step, the user inputs a first phrase query to identify one or more phrases and the associated tags, and the program identifies all of those records containing the selected tags, indicated by the document subset 1 in FIG. 14A. In a second search step, the user employs a second phrase query to identify a second group of one or more related tags that ideally (i) represent a substantially different statement, proposition, or content from that of the first query, (ii) are likely to be found in records of interest, and (iii) are likely to preserve a relatively large number of records in the library being searched. The search results for this query are shown by the document subset 2 shown in FIG. 14B. The intersection of the two subsets represents those records containing tags from both of the first two queries.

At any time after the first query, but typically after 2-3 user-directed queries, the user may switch to the system-directed mode to find tags that represent relevant statements or propositions that the user believes would likely be found in a record of interest and, at the same time, condense the size of the record search space in an orderly way, particularly to avoid having the record search space collapse drastically before additional relevant statements (phrases) can be considered. As discussed above, the system-directed mode, also known as autosearch, functions to identify additional “test” tags that (i) are associated with each of the previous tag queries and (ii) let the user know how many records are preserved with each of these test tags. In the present case, where autosearch is used after two user-directed queries, the first autosearch will produce a list of tags that overlap with tags from the first two groups, and FIG. 14C shows four 0of these groups, indicated at 3j, 3k, 3l, and 3h. Of these, assume the user selects the largest group “3i”, which now becomes record subset 3, and then conducts a second autosearch to find those pertinent tags that overlap with each of the first three subsets. FIG. 14D shows three of the possible newly generated tag subsets 4j, 4k, and 4l. Assume now that the user selects two of these, 4j, and 4k as the fourth subset, and repeats the autosearch once more. FIG. 14E shows this result, where one of the tag subsets, “5i,” overlaps all four of the previous ones, is presumably relevant, and is selected as the final search query.

From the foregoing, it can be appreciated how tag-based searching involved a combination of user-directed and system-directed search modes, allows a user to find one or a small number of records among a large number, e.g., several hundred thousand of more document in a database. First, the phrase word query is robust in the sense that tags of interest can be retrieved without knowing the exact wording or language associated with the tag.

Secondly, with the assumption that every record (or at least small subsets of records) can be uniquely identified by a relatively small number of phrases and associated tags, the user is able to locate this record or a small numbers of related records by directing queries aimed at these few “record-defining” phrases. To this end, the system in its system-directed mode functions to prompt the user in the selection of additional tags that are both pertinent to the record being sought and still preserve a substantial number of records. Finally, once a small number of record-defining tags have been identified, the user may easily assess the quality of the search simply by reviewing the tag-related phrases, without having to review the entire document for content.

G. User Interfaces

FIG. 15 shows a graphical interface in the system of the invention for use in record searching. The interface includes a query box 312 in which the user enters a phrase query, e.g., a sentence or sentence fragment or key words of a phrase corresponding to a tag of interest. Once this query is entered, the user clicks on the “Add Query” button, signaling the program to identify the non-generic query words, and construct the appropriate search vector. This query is identified as the first query in the query list at 314. To start the search, the user clicks on the “Search” button, which initiates the phrase word-match search described above with respect to FIG. 8.

When this initial phrase search is completed, the top-matched phrases are displayed in statement box 316, which also shows the tag ID for each statement. By clicking on a tag in box 316, the program will show all of the phrases for that tag in box 318 for “Expanded Statement”. (In some record libraries, e.g., libraries of citation-rich records, a tag may be associated with more than one phrase; in other record libraries, e.g., patent document, there may be only one phrase per tag). By clicking on a tag ID in box 316, the program will also show the full tag data in box 320. As discussed above, the phrases and tags shown in box 316 can be ranked and displayed by Match Score, Tag (Citation) Date, and Record (Document) Count, using the radial buttons at 322. The top “Select” button in this group is used to select one or more tags in a query (search stage).

At this point, the user may initiate another round of searching, by entering a new query, and repeating the steps of evaluating and selecting one or more “second-stage” tags. At any time during the search, the user may switch to a system-directed mode by clicking on the “Find Citations” button, which initiates the program operations of (i) finding test tags (citations) that have high co-occurrence (and/or co-clustering) with the tags already selected by the user, and (ii) determining the number of records containing at least one tag in each of the already selected groups and the test tag, and (iii) presenting these to the user, e.g., ranked by total number of records.

At the completion of the search, which can include both user-directed and system-directed modes, the user can request a query summary, in box 324, which displays, for each query number form box 314, the tags selected in that query. The user can also request, for any query, a summary of records containing that query and all previous queries. The record information, including record ID, date, selected tags, and corresponding phrases is presented in box 326. It will be appreciated that all of the interface text boxes may switch to a scroll-down mode when they contain more text than the display panel can handle.

While the invention has been described with respect to particular embodiments and applications, it will be appreciated that various changes and modification may be made without departing from the spirit of the invention.

It is claimed:

1. A computer database method for finding a record of interest in a library of records characterized by distinction subsets of tag descriptors, comprising
(a) accessing a database table to identify, from user-generated information, one or more tag-descriptive phrases likely to be contained in or associated with a record of interest,
(b) from the phrase(s) identified in step (a), identifying one or more tags associated with the identified phrase(s),
(c) accessing a tag-affinity database table to identify test tags associated in the library records with those identified in step (b),
(d) accessing a database table of searchable tags, to generate for each of the test tags identified in step (c), data related to the number of library records containing in or associated with that test tag and the tags identified in step (b), and
(e) presenting the number-of-records data generated in (d) to a user.

2. The method of claim 1, wherein step (a) includes the steps of (ai) accessing a word-records database table composed of searchable words, and for each word in said table, a list of identifiers of phrases containing that word, to identify from a user-generated, word-based query, those phrases having the highest element overlap with the query words, and (ai) presenting those highest-overlap phrases to the user, for user selection of one or more phrases.

3. The method of claim 2, wherein step (b) includes accessing a phrase database table composed of phrase identifiers, and for each phrase identifier, a list of one or more tags associated with that phrase, to identify one or more tags associated with the phrase(s) identified in step (a).

4. The method of claim 3, wherein the phrase database table further includes, for each phrase identifier, the actual phrase associated with each phrase identifier, and step (a) includes accessing the searchable-phrase table to retrieve and present to the user, the actual phrase(s) associated with the identified phrase identifier(s).

5. The method of claim 1, wherein steps (a) and (b) are carried out iteratively, prior to step (c), where each successive iteration yields one or more newly identified phrases and associated tags to add to the previously identified phrases and associated tags from all previous iterations.

6. The method of claim 5, wherein at each iteration, there is displayed along with those phrases identified in step (a), the number of library records containing both previously identified and newly identified tags, where the iterations of steps (a) and (b) are continued until the number of records containing the selected and identified citations is desirably small.

7. The method of claim 1, wherein the affinity database table accessed in step (c) is a t×t matrix of all tags t associated with said records, and the matrix values for each word pair in the matrix is related to the number occurrence of both tags in the pair in said records.

8. The method of claim 1, wherein step (d) includes (d1) determining for each of the tags identified in (c), the total number of library records containing that test tag and one or more of the previously identified tags previously identified by steps (a) and (b), (d2) displaying those test tags identified from step (c) having the highest total number of library records determined from (d1), along with the number of records so determined, and (d3) allowing the user to select one or more tags displayed in (d2).

9. The method of 8, wherein each tag in the database table of searchable tags accessed in step (d) is represented as an N-dimensional vector, where N is the total number of library records in the system, and the coefficient of each vector term is a binary coefficient that indicates whether that tag is in the associated library record represented by that term, and step (d1) includes adding the vectors corresponding to one or more previously identified tags with that of a test tag by AND addition of the vector coefficients, and counting the coefficients from the added vectors.

10. The method of claim 9, wherein the one of more tags identified in step (b) include two of more groups of tags identified from two or more iterations of steps (a) and (b), respectively, where each group includes one or more tags, and step (d1) includes adding the coefficients of vectors in each group by OR addition, to generate a group vector, then adding the group vector(s) with that of a test tag by AND addition, and counting the coefficients in the summed vector.

11. The method of claim 1, wherein step (e) further includes selecting one or more tags presented in step (e), adding the selected tags to those identified in step (b), and repeating steps (c)-(e), until a desirably small number of records are presented in step (e).

12. The method of claim 1, for finding a record document of interest in a library of citation-rich documents, wherein said tags are citations appearing in said documents and said phrases are statements or propositions in said documents in close proximity to said citations.

13. The method of claim 1, for finding a record patent of interest in a library of patents, wherein said tags are class and subclass numbers assigned to said patents and said phrases are definitions of the classes and subclasses associated with said numbers.

14. The method of claim 1, for finding a disease record in a library of disease records, wherein said tags are symptoms identifiers, and said phrases are descriptions of symptoms associated with said tags.

15. The method of claim 1, for finding a subject record in a library of subject records, wherein said tags are personality or preference identifiers and said phrases are descriptions of personality or preference traits associated with said tags.

16. A database system for finding a record of interest in a library of records characterized by distinction subsets of tag descriptors, comprising
(a) a computer,
(b) database tables accessible by said computer, including:
(i) a word-records table composed of searchable words, and for each word in said table, a list of identifiers of phrases containing that word,
(ii) a phrase table composed of phrase identifiers, and for each phrase identifier, a list of one or more tags associated with that phrase,
(iii) an affinity matrix whose matrix values represent, for each pair of tags in the system, a number related to the affinity of the two tags of the pair in said records, and
(iv) a tag table in which each tag is represented as an N-dimensional vector, where N is the total number of library records in the system, and the coefficient of each vector term is a binary coefficient that indicates whether that tag is in the associated library record represented by that term, and
(c) computer-readable code executable by said computer to:
(i) access the word-records table to identify, from user-generated information, one or more phrases likely to be contained in or associated with a record of interest,
(ii) access the phrase table to identify one or more tags associated with the phrase(s) identified in (i),
(iii) access the affinity matrix to identify additional test tags associated in the library records with those identified in step (ii),
(iv) access the tag table to generate for each of the test tags identified in step (iii), data related to the number of library records containing in or associated with that test tag and the tags identified in step (ii), and
(v) present the number-of-records data generated in (iv) to a user.

17. The system of claim 16, wherein said affinity matrix is a t×t matrix of all tags t associated with said records, and the matrix values for each word pair in the matrix is related to the number occurrence of both tags in the pair in said records.

18. The system of claim 17, wherein the sum of the matrix values of each row of the matrix are normalized to a common value.

19. A database for use by an electronic computer for finding a record of interest in a library of records, comprising
(i) a word-records table composed of searchable words, and for each word in said table, a list of identifiers of phrases containing that word,
(ii) a phrase table composed of phrase identifiers, and for each phrase identifier, a list of one or more tags associated with that phrase,
(iii) an affinity matrix whose matrix values represent, for each pair of tags in the system, a number related to the affinity of the two tags of the pair in said records, and
(iv) a tag table in which each tag is represented as an N-dimensional vector, where N is the total number of library records in the system, and the coefficient of each vector term is a binary coefficient that indicates whether that tag is in the associated library record represented by that term.

20. The system of claim 19, wherein said affinity matrix is a t×t matrix of all tags t associated with said records, and the matrix values for each word pair in the matrix is related to the number occurrence of both tags in the pair in said records.

21. The system of claim 20, wherein the sum of the matrix values of each row of the matrix is normalized to a common value.
